(19) United States
(12) Patent Application Publication
(10) Pub. No.: US 2002/0159112 A1
(43) Pub. Date: Oct. 31, 2002

(54) Device and method for reducing polarization dependent loss in an optical monitor device

(76) Inventors: David A. Coppeta, Atkinson, NH (US); Steven J. Kane, Chester, NH (US)

Correspondence Address: William F. Esser, Esq., Jenkens & Gilchrist, P.C., Suite 3200, 1445 Ross Avenue, Dallas, TX, 75202-2799, US

(21) Appl. No.: 10/121,915

(22) Filed: Apr. 12, 2002

Related U.S. Application Data
(60) Provisional application No. 60/283,698, filed on Apr. 13, 2001.

(51) Int. Cl. H04B 10/08; H04B 10/02

(52) U.S. Cl. 359/110; 359/177

(57) ABSTRACT

A device and method for monitoring characteristics of optical signals in an optical telecommunications system are disclosed. The device includes a wedge of birefringent material disposed in an optical path of the device. The thickness of the wedge of birefringent material varies in at least one dimension along the direction of propagation of an optical beam passing through the device. The variation in wedge thickness causes the polarization state of the optical beam to be a function of position along the wedge. The composite energy in the optical beam appears to be formed of two orthogonal polarization components with no phase relationship to each other. If the two orthogonal polarization components of the optical beam are disposed at a predetermined angle relative to the principal efficiency axes of the device, such as approximately 45 degrees, the polarization dependent loss of the device is substantially reduced.

### BACKGROUND OF THE INVENTION

1. Technical Field of the Invention

The present invention relates to a device for monitoring optical signals in an optical telecommunications network, and particularly to a monitoring device having reduced polarization dependent loss.

2. Description of the Related Art

With the increasing demand for bandwidth driven by the Internet, as well as more traditional telecom services, global bandwidth is doubling approximately every 100 days. The ability of networks to handle this increase in demand is made possible by the industry shift to Dense Wavelength Division Multiplexing (DWDM).

Networks which support DWDM typically allocate a center wavelength for each channel that a fiber is to carry. Because each channel has its own distinct wavelength, the information carried by each physical link is increased by the number of wavelengths used. This provides a tremendous cost advantage and allows information-carrying capacity to grow without having to run an additional fiber for each channel. Increasingly, existing optical networks typically deploy optical performance monitors (OPMs) to measure critical parameters of the physical link such as the power, center wavelength, and the optical signal to noise ratio (OSNR) associated with each channel. An OPM is essentially a spectrometer. The measurement of these parameters is ideally accurate over time, temperature, and other environmental factors in order for problems in the physical link to be correctly identified. The measurement of parameters of a physical link by an OPM may also be used to enable applications such as laser locking and gain balancing.

Diffraction grating-based OPMs typically have high and low efficiency polarization states which are orthogonal to one another. These particular polarization states shall be referred to as the principal efficiency axes.

Most OPMs have some form of inherent Polarization Dependent Loss (PDL) associated therewith. PDL refers to the relative change in measured optical power as a function of the input optical polarization state. PDL is highly undesirable, as typically there is no apriori knowledge of the input polarization state of an optical signal appearing at the input of an OPM. Furthermore, due to the temperature dependent birefringence of optical fiber, the polarization state of the signal measured by the OPM will vary with the temperature profile along the entire physical link. To complicate things further, channels may be added and dropped at different points in the network, such as within an optical add-drop device, thereby causing the optical polarization state to be channel dependent.

OPMs typically include a diffraction device to diffract an optical input beam as a function of channel wavelength in order to facilitate the measurement of various channels of an input optical beam. Diffraction grating-based OPMs are especially vulnerable to PDL due to the fact that diffraction efficiency of a diffraction grating is polarization dependent. As a result, a great deal of effort is typically spent designing diffraction gratings with low PDL.

A typical OPM device is generally depicted in FIG. 1. The OPM's source spot 101 may be from an input fiber itself or an image thereof. The source optical spot 101 is substantially collimated by lens system 102 and diffracted by a transmission diffraction grating 103. In this case, the diffraction grating's periodic index pattern is along the y-axis. The diffraction grating 103 has different efficiencies depending on whether the electric field is polarized parallel or perpendicular to the grating pattern. Light diffracted from the diffraction grating 103 would typically be focused, via lens system 104, down to a spot 105 and imaged onto a detector 106. It should be pointed out that for a diffraction-based scanning spectrometer/OPM, the detector 106 would typically be single element with an aperture in front to provide the spectral selectivity (resolution). For a non-scanning spectrometer/OPM, the detector 106 would typically be a linear pixilated detector array. Because the diffraction efficiency of the OPM of FIG. 1 is polarization dependent (due to diffraction grating 103), the power measured at detector 106 varies with input polarization, even when input optical power is held constant. PDL in an OPM may also be caused by optical signals reflecting off surfaces of OPM components at relatively steep angles. The reflecting surfaces lack symmetry between the two polarization states. For example, reflection off a flat metallic mirror at an angle will cause PDL because there is a lack of symmetry between the two polarization states and how they are incident on the mirror.

Based upon the foregoing, there is a need for an improved OPM device for monitoring optical signals in an optical communications network having reduced PDL.

### SUMMARY OF THE INVENTION

Embodiments of the present invention overcome shortcomings of prior OPM devices and satisfy a significant need for an OPM device having relatively low PDL. An OPM, according to embodiments of the present invention, reduces PDL by placing a spatially dependent polarization shift on an input beam to the OPM such that the composite energy in the beam appears to be made of two orthogonal linear polarization components with no average phase relationship to each other. By rotating these two orthogonal states relative to the principal efficiency axes of the OPM (i.e., the high and low efficiency polarizations states of a diffraction grating in the OPM) by a predetermined amount, the PDL may be averaged to be near zero and the overall OPM efficiency is the average of the high & low efficiency axes of the OPM.

In an exemplary embodiment of the present invention, a wedge of birefringent material is disposed in the optical path of the OPM device such that the ordinary and extraordinary axes of the wedge are rotated by the predetermined amount with respect to the direction of propagation of optical beams in the OPM. The thickness of the wedge of birefringent material varies along a direction substantially perpendicular to the direction of beam propagation and determines the relative phase shift between the ordinary and extraordinary polarization states of the beam passing through the wedge. As a result, the polarization state of the beam leaving the wedge will be a function of the transverse spatial coordinate along the axis of wedge thickness variation.

In particular, the phase relationship between the ordinary and extraordinary polarization states of the beam exiting the wedge of birefringent material continuously varies as a sinusoidal function of the transverse spatial coordinate. If the dimension of the wedge is selected so as to cause one or more periods of the variation of the polarization state of the beam, the output beam, when spatially integrated, approximates the input beam decomposed into the two principal axes of the wedge with no average phase relationship with respect to each other. If the ordinary and extraordinary axes of the wedge of birefringent material are clocked at approximately 45 degrees from the principal efficiency axes of the OPM and/or the diffraction grating therein, the PDL of the OPM is approximately zero and the efficiency of the OPM is approximately the average of the principal efficiency axes of the OPM/diffraction grating.

### BRIEF DESCRIPTION OF THE DRAWINGS

A more complete understanding of the system and method of the present invention may be obtained by reference to the following Detailed Description when taken in conjunction with the accompanying Drawings wherein:

FIG. 1 is a block diagram of a conventional OPM;

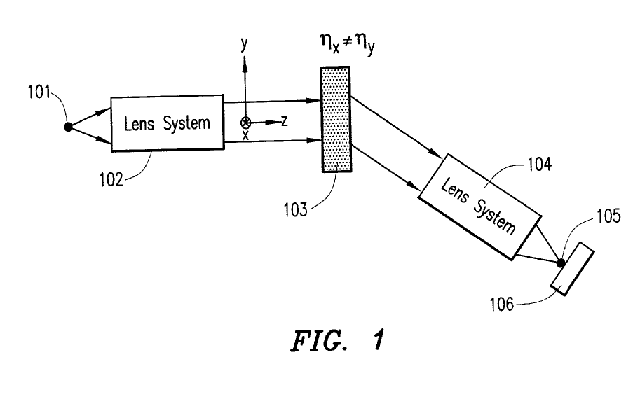

FIG. 2 is an elevational view of a birefringent wedge and corresponding beam waveforms according to an exemplary embodiment of the present invention;

FIGS. 3A-3C are diagrams of the polarization state of beams associated with the birefringent wedge of FIG. 2;

FIGS. 4A and 4B are elevational views of a wedge plate according to an exemplary embodiment of the present invention;

FIG. 5 is a block diagram of an OPM according to an exemplary embodiment of the present invention;

FIGS. 6A-6C are beam diagrams associated with the OPM of FIG. 5;

FIG. 7 is a block diagram of an OPM according to another exemplary embodiment of the present invention;

FIG. 8 is a block diagram of an OPM according to another exemplary embodiment of the present invention;

FIG. 9 is a block diagram of an OPM according to another exemplary embodiment of the present invention;

FIG. 10 is a flow chart illustrating an operation of the OPM of FIG. 5; and

FIG. 11 is a block diagram of an OPM according to another exemplary embodiment of the present invention.

### DETAILED DESCRIPTION OF THE EXEMPLARY EMBODIMENTS

The present invention will now be described more fully hereinafter with reference to the accompanying drawings in which exemplary embodiments of the invention are shown. This invention may, however, be embodied in many different forms and should not be construed as being limited to the embodiments set forth herein. Rather, the embodiments are provided so that this disclosure will be thorough and complete, and will fully convey the scope of the invention to those skilled in the art.

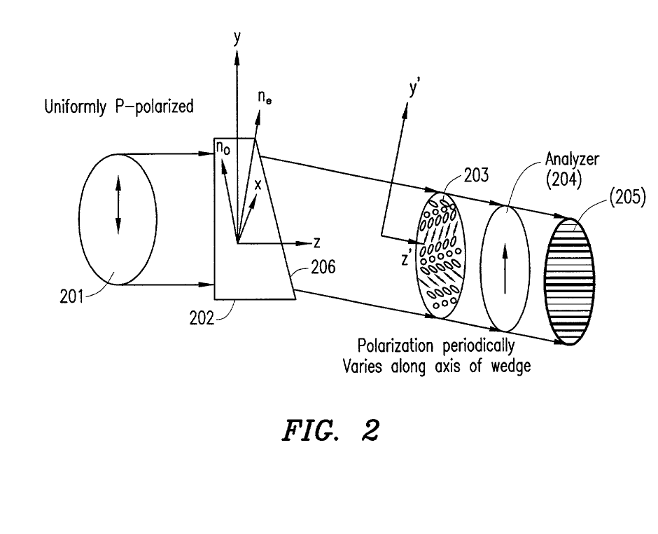

Embodiments of the present invention reduces or otherwise eliminate PDL in an OPM by transforming an input optical wavefront of substantially uniform polarization state into an optical wavefront whose polarization varies along a single spatial dimension. Embodiments of the present invention reduce PDL in an OPM by employment of a wedge of birefringent material therein. Referring to FIG. 2, there is shown a wedge 202 of birefringent material showing principles of the present invention utilized in reducing PDL in an OPM. A quasi-collimated optical input beam 201 has an electric field oriented along the y-axis, travels along the z-axis and is incident on a wedge 202 of birefringent material. It is understood that input beam 201 being polarized along the y-axis is shown for exemplary purposes only, and that input beam 201 may be polarized in other polarization states. The ordinary axis nₒ and the extraordinary axis nₑ of wedge 202 are rotated approximately 45 degrees with respect to the x-y plane. The surface 206 of wedge 202 is angled or oriented relative to the y-axis. Light entering the wedge 202 may be decomposed into polarization states along the ordinary and extraordinary axes of the wedge 202. The thickness of the wedge 202 along the direction of propagation of input beam 201 determines the relative phase shift between two principal polarization states and thus the output polarization state. Since the wedge surface 206 is angled, the thickness of the wedge 202 of birefringent material is a function of position along the y axis. As a result, the polarization state of the output beam 203 will be a function of position along the y′-axis of beam 203, which itself depends upon the wedge y-axis and the angle of wedge 202. It should be noted that more than one surface of the wedge 202 may be angled.

If an analyzer 204, whose axis of transmission is rotated with respect to either of the wedge's principal planes, is placed on the output side of wedge 202 in the path of output beam 203, one would see a sinusoidally varying intensity pattern 205. The polarization of output beam 203 periodically varies along the y′-axis of beam 203. If the angle of surface 206 of wedge 202 is such that one or more periods of the polarization state variation occurred, then if spatially integrated, the output beam 203 approximates the input beam 201 broken down into the two principal polarization (ordinary and extraordinary) axes of wedge 202 with no average phase relationship with respect to each other.

It is understood that the spatial mode of the beam 201 determines how many, or few, periods of the spatially varying polarization are required per unit length for the energy to spatially average to achieve an approximately zero phase relationship. It is also understood that a similar effect can be achieved using circular birefringence rather than linear birefringence. In this case, birefringence will be treated as linear birefringence for exemplary purposes only, with the understanding that the principles of the present invention also include use of a circular birefringence.

For maximum reduction in PDL, the principal axes of the wedge 202 may be oriented or rotated by approximately 45 degrees with respect to the principal efficiency axes of the corresponding OPM. Consequently, an input beam 201 whose polarization is along one of the principal polarization axes of wedge 202 will be transmitted with substantially no change in polarization state. For input beams 201 whose polarization are not along one of the principal polarization axes of the wedge 202, the polarization state of the output beam averages to a substantially equal split between the two principal efficiency axes due to the rotation of the principal axes of wedge 202 with respect with the principal efficiency axes of the OPM in which wedge 202 may be disposed.

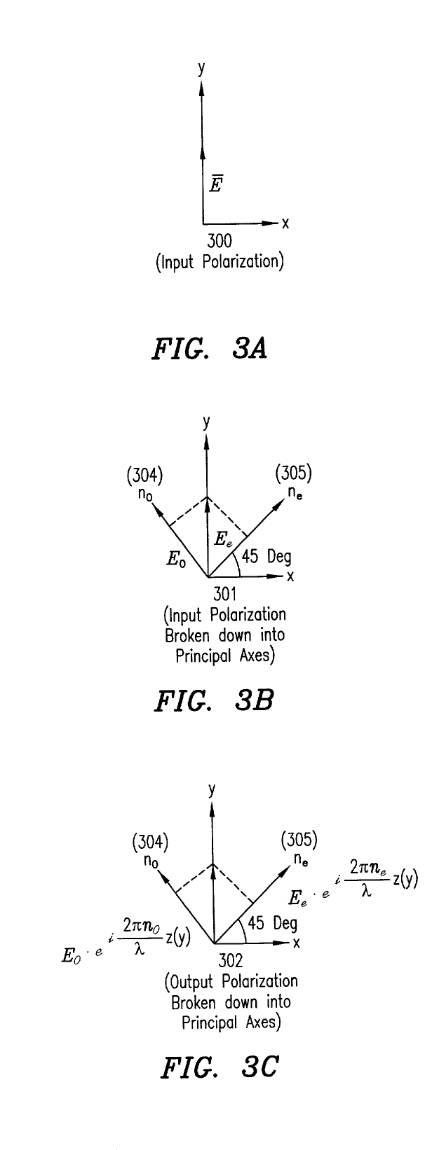

The above-described spatial averaging of the phase of the output beam 203 is further illustrated in FIGS. 3A-3C. The input beam 201 may be polarized along the y-axis as shown FIG. 3A. It is understood that the polarization along the y-axis is for illustrative purposes only, and that input beam 201 may be polarized in other directions. Upon entering the birefringent wedge 202, the polarization state of the beam may be broken down into two components along the principal polarization axes of wedge 202 as shown in FIG. 3B. Upon traversing the wedge 202, the polarization of output beam 203 is shown in FIG. 3C. The polarization of output beam 203 includes exponential phase factors defined along the ordinary axis nₒ and extraordinary axis nₑ of wedge 202 that are unequal due to the difference in index of refraction between the ordinary and extraordinary axes. Integrating output beam 203 over the spatial dimensions of wedge 202, in order to measure power, causes the phase relationship between the two principal polarization states to have a sinusoidal beat term. The sinusoidal beat term averages to approximately zero, thereby resulting in substantially no phase relationship between the principal polarization axes of wedge 202.

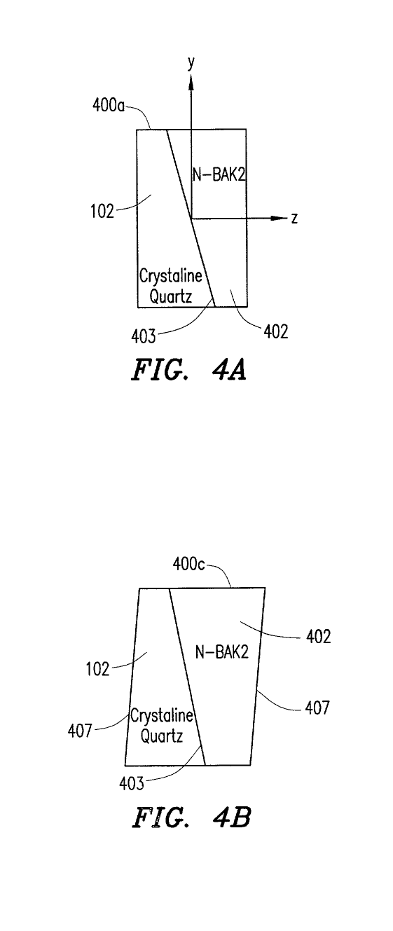

The angular tilt created due to the refraction from the wedge 202 may be undesirable. Referring to FIG. 4A, there is shown a wedge plate 400a having a wedge 102 of birefringent material and a glass compensating wedge 402. As with wedge 202 of FIG. 2, the birefringent material of wedge 102 may be crystalline quartz, but it is understood that the material of wedge 102 may be any linear birefringent or circularly birefringent material. Similarly, the compensating wedge 402 may be any glass having an index of refraction that substantially matches the index of refraction of the birefringent material of wedge 102, such as N-BAK2 manufactured by Schott Glas or a subsidiary thereof. Alternatively, the compensating glass of wedge 402 could be a birefringent material whose principal axes are rotated with respect to the principal axes of wedge 102 by approximately 45 degrees. This forms a Halle depolarizer. It is understood that the angle of the surface 403 may be common between wedges 102 and 402. Alternatively, wedges 102 and 402 may be spaced from each other. In this alternative case, the angle of wedge surface of wedges 102 and 402 may be substantially equal. The wedge plate 400a formed by wedges 102 and 402 performs substantially the same function as the wedge 202 of FIG. 2 but advantageously has little if any angular tilt of the output beam relative to the input beam due to refraction.

In some high dynamic range OPMs, employment of a wedge or wedge plate having a flat surface relative to the direction of propagation of a light beam may be less desirable because beam reflections may propagate to the detector of the OPM. Another alternative to wedge plate 400a is shown in FIG. 4B. The wedge plate 400c includes input & output surfaces 407 that are angled by substantially equal amounts so as to cause substantially no angular deviations to the main beam but send reflections off at an angle. Note that in this case, the choice of the angle of surface 403 will depend on the desired thickness variation of the wedges 102 and 402 as well as the choice of angles of surfaces 407.

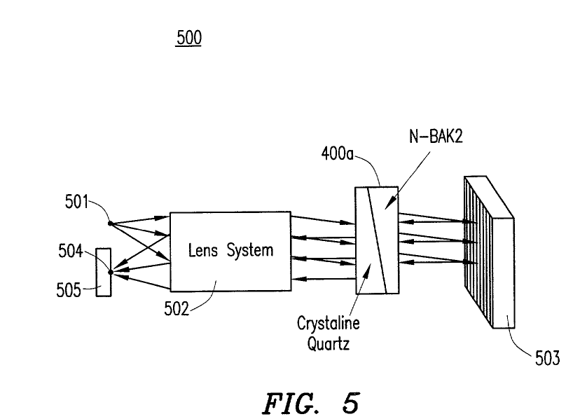

Referring to FIG. 5, there is shown an OPM 500 according to an exemplary embodiment of the present invention. A source optical spot 501, which is assumed Gaussian but more generally may have any mode shape, is collimated by lens system 502. The collimated beam makes a first pass through the wedge plate 400a. Wedge plate 400a may include birefringent wedge 102 whose ordinary and extraordinary axes are rotated at approximately 45 degrees with respect to the principal efficiency axes of the diffraction grating 503 and/or OPM 500. The approximately 45 degree rotation may be either positive or negative. As discussed above, after passing through the birefringent wedge 102, the principal polarization components of the beam may have accumulated spatially varying phase factors, as shown in FIG. 3C. Wedge plate 400a may include compensating glass wedge 402 which minimizes the linear tilt from the wedge 102, as discussed above.

The spatially varying phase shift between the two principal polarization states of the beam exiting wedge 102 ensure that when the energy is integrated on a detector 505, the two polarization states appear independent of one another. The beam diffracts off the diffraction grating 503 with an efficiency equal to the average of the high and low efficiencies of diffraction grating 503 due to the approximately 45 degree rotation or phase offset between the principal efficiency axes of diffraction grating 503 and that of the two polarization states of the incident beam. Following the optical path from diffraction grating 503, the diffracted light passes through the wedge plate 400a a second time and is imaged onto the detector 505.

It is understood that OPM 500 may have the ability to measure wavelength, OSNR and power. The detector 505 may be an array of pixilated detectors in the case of a spectrometer having no moving parts. In the case of a moving diffraction grating, such as in a scanning-based optical spectrum analyzer (OSA), a slit would be placed in front of a single element detector to give spectral selectivity for sequentially measuring wavelength and power of the input beam.

The thickness variation of the birefringent wedge 102 may depend on a number of factors including the effective focal length (EFL) of the lens system 502, the size of detector 505, optical signal wavelength, the desired reduction in PDL, and the indices of refraction of the components in OPM 500.

Two main effects leading to spot spreading as a function of input polarization state are diffraction and refraction. Both effects spread the spot along the axis of the wedge angle. Diffraction comes about due to the spatially varying polarization state being induced. This variation of polarization state causes a sinusoidal intensity modulation for any two orthogonal polarization states into which the beam can be decomposed (i.e. basis states). The sinusoidal modulation of polarization state diffracts similarly to a diffraction grating. Scanning and diffraction grating based optical spectrum analyzers (OSAs) may not be concerned with this diffraction effect if the detector element is large. Such OSAs would only need to orient the axis of wedge 102 such that it is aligned with the slit aperture's longitudinal dimension. OPM devices which employ linear focal plane arrays tend to have smaller pixel dimensions. Thus the wedge thickness and angle selection are a more important consideration for proper operation of OPMs having linear focal plane detector arrays.

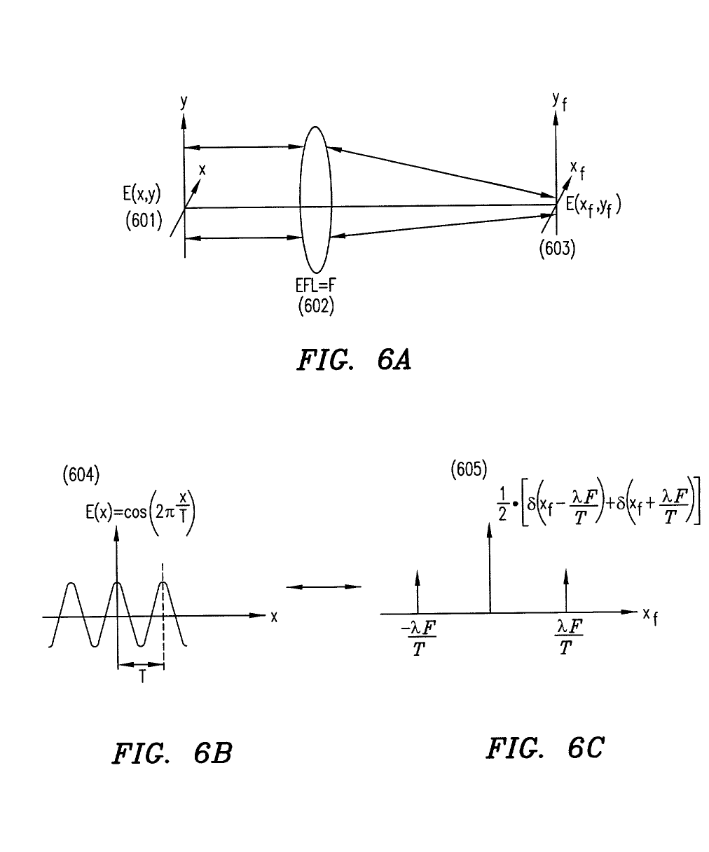

The extent of the diffraction is relatively easy to predict. Referring to FIGS. 6A-6C, the Fourier transform relationship between the electric field amplitude at the focal plane 603 and that in collimated space 601, and assuming a lens system 602 with effective focal length F, may be represented as

E(x_{f}, y_{f})=∫∫E(x,y)*e^{-j(2π/λF)*(x*x}^{_{f}}^{+y*y}^{_{f}}⁾dxdy

where x_{f} and y_{f} are the focal plane spatial coordinates. As can be seen, if the electric field amplitude's spatial distribution is a sinusoid in collimated space as shown in FIG. 6B, the field amplitude at the focal plane would be given by two delta functions at positions +/−λF/T as shown in FIG. 6C. Since the polarization state modulation is sinusoidal, due to the wedge plate 400a, the field amplitude in collimated space would be the product of the Fourier Transform of the input spot (assumed Gaussian) and the sinusoidal modulation. Thus the spatial field distribution in the focal plane would be a Gaussian convolved with the two delta functions, i.e., two Gaussians separated by 4*λF/T. Note that the extra factor of two is due to the fact that in the reflection based OPM 500 of FIG. 5, a second pass of the beam occurs through the wedge plate 400a and thus the effective sinusoidal period is doubled. The period T of the sinusoidal modulation will be a function of the input polarization state of the input beam. If the input polarization corresponds with one of the principal axes of wedge 102, then T=° and the two Gaussians collapse into a single Gaussian at the origin of the focal plane 603. If the input polarization is circular, then there will be an equal amount of power in each polarization state and, for a wedge angle θ,

T=λ/[(n_{c}−nₒ)*sin(θ)].

Therefore, as the input polarization state changes, the focal plane power distribution is that of two Gaussians whose separation varies. As a result, there are competing goals of providing a large wedge angle to minimize PDL and providing a smaller wedge angle to prevent overfilling detector pixels of fixed dimension in the non-dispersion direction.

One method to reduce the spot spreading is to start with an astigmatic spot. If spot 501 in FIG. 5 is astigmatic such that the spot was smaller in the non-dispersion direction, the diffractive spreading would be reduced as compared to the case of a symmetric spot, due to a reduced wedge angle being required for the same PDL reduction. Of course this assumes that both cases hold the spot size in the dispersion direction the same.

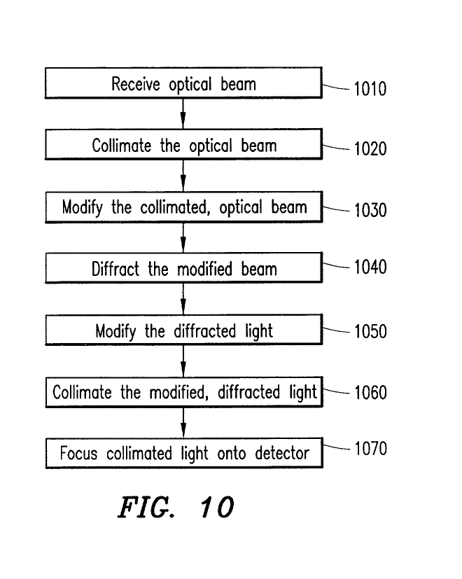

An operation of OPM 500 will be described with reference to FIG. 10. Initially, an optical beam is received at spot 501 at 1010. Next, lens system 502 collimates the optical beam at 1020. The collimated optical beam is modified by wedge plate 400a at 1030. The optical beam exiting wedge plate 400a has a spatially varying polarization state, as described above, with a component of linear polarization appearing along the ordinary axis nₒ of wedge 102 and a component of linear polarization appearing along the extraordinary axis nₑ thereof. The linear polarization components, averaged spatially, have substantially no phase relation to each other, and are each rotated approximately 45 degrees relative to the principal efficiency axes of diffraction grating 503. The modified optical beam is diffracted from diffraction grating 503 at time 1040. The diffracted light passes through wedge plate 400a at 1050 and is collimated by lens system 502 at 1060 so as to be focused onto detector 505 at 1070.

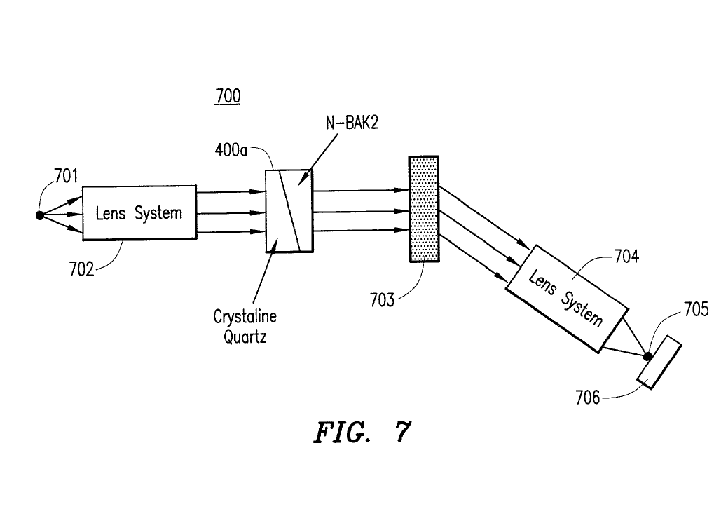

Referring to FIG. 7, there is shown an OPM 700 according to another exemplary embodiment of the present invention. OPM 700 is a diffraction grating-based spectrometer in a transmission mode. In this case, the object spot 701 is collimated by a lens system 702. A beam collimated by lens system 702 passes through wedge plate 400a only one time. The polarization state of the beam spatially varies, as discussed above. The beam is diffracted by transmissive diffraction grating 703 to provide channel dispersion. A lens system 704 is disposed in the optical path to receive and re-image the diffracted light towards the focal plane 705. A detector and/or detector array 706 is disposed at the focal plane 705. It is understood that although OPM 700 may be physically larger than OPM 500, light passes through wedge plate 400a only once. Consequently, the diffractive spreading of the spot along the direction of wedge 102 will be cut approximately in half, relative to the diffractive spreading of the spot in OPM 500.

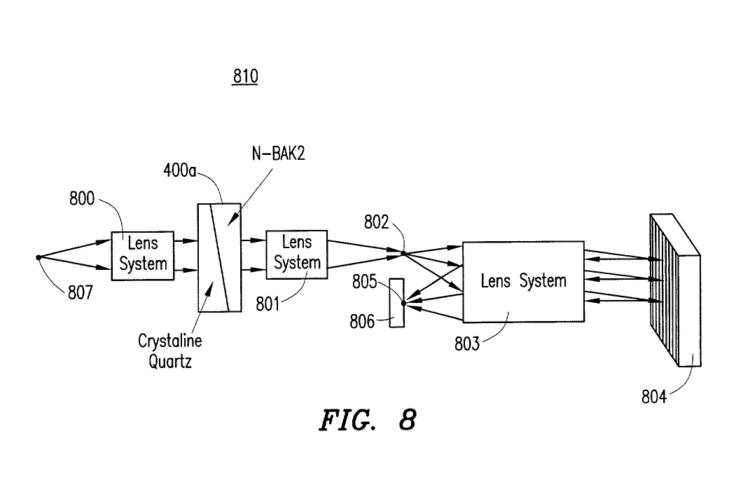

A third exemplary embodiment of the present invention is shown in FIG. 8. OPM 810 is a reflection based diffractive spectrometer. In this case, the input spot 807, such as a spot appearing at the end of an input fiber, is collimated by a lens system 800. The wedge plate 400a is disposed to receive a beam collimated by lens system 800. The output of the wedge plate 400a has a spatially varying polarization, as discussed above with respect to FIGS. 2-4, and is focused to intermediate spot 802 via lens system 801. The intermediate spot 802 is collimated by lens system 803 and diffracted by reflective diffraction grating 804. The diffracted light passes through lens system 803 and is imaged at spot 805. A detector and/or detector array 805 is placed in the focal plane at spot 805 to detect the diffracted, collimated optical signal. Design considerations of OPM 810 are similar to that of OPM 500 of FIG. 5 with the exception that only a single pass is made through the wedge plate 400a, so that the diffractive spreading of the spot along the wedge axis of the wedge plate 400a is reduced relative to the diffractive spreading in OPM 500.

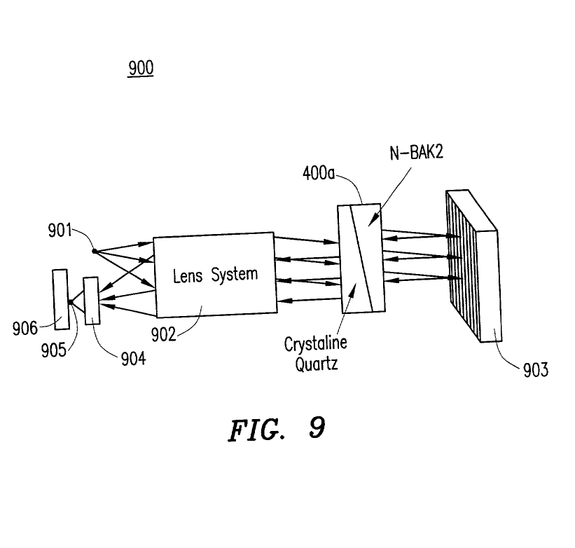

Referring to FIG. 9, there is shown an OPM 900 according to a fourth exemplary embodiment of the present invention. The OPM 900 is similar to the OPM 500 of FIG. 5 with the exception that an optical system 904 with astigmatic optics (i.e., having power in one dimension only) is inserted in the optical path between lens system 902 and detector 906. The astigmatic optical system 904 may be made of a small positive-negative cylindrical lens pair. Alternatively, astigmatic optical system 904 may employ an anamorphic prism pair. The function of the astigmatic optical system 904 is to change the magnification of the spectrometer so as to reduce the optical spot size in the non-dispersion dimension. Since the non-dispersion dimension is the direction along which the wedge axis is oriented, a reduction of spot size in this dimension will reduce the diffractive spreading induced by the wedge plate 400a.

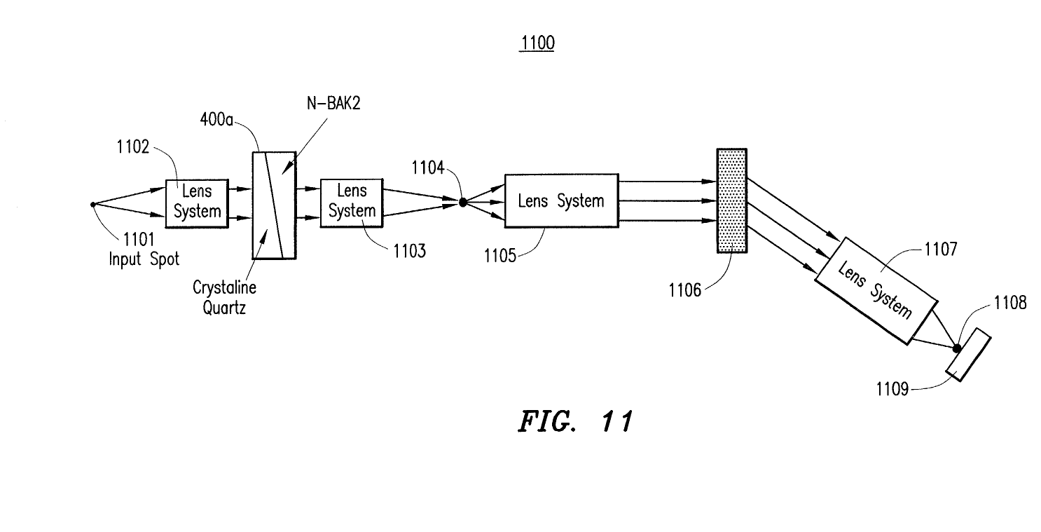

Another exemplary embodiment of the present invention is based upon the OPM 810 of FIG. 8 and OPM 700 of FIG. 7. With reference to FIG. 11, OPM 1100 includes a lens system 1102, wedge plate 400a and lens system 1103 which function the same as lens system 800, wedge plate 400a and lens system 801 of OPM 810, respectively. The intermediate spot 1104 is collimated by lens system 1105 and diffracted by transmission diffraction grating 1106. The diffracted light is received by lens system 1107 and reimaged towards focal plane 1108. A detector and/or detector array 1109 is disposed at the focal plane 1108. As can be seen, lens system 1105, diffraction grating 1106, lens system 1107 and detector 1109 function the same as lens system 702, diffraction grating 703, lens system 704 and detector 706 of OPM 700 of FIG. 7. OPM 1100 provides a similar result as OPM 700 of FIG. 7. Components of OPM 1100, such as lens system 1102, wedge plate 400a and lense system 1103, may be constructed as a single microoptic subassembly so that OPM 1100 may be reduced in size.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An optical monitor device for monitoring one or more optical signals in an optical communications network, comprising:
an input port coupled to an end of a fiber optic line;
a collimating lens assembly disposed relative to and in optical communication with the end of the fiber optic line, for substantially collimating an optical beam emitted from the end of the fiber optic line to produce a substantially collimated optical beam having a substantially uniform polarization state;
a wedge of birefringent material in optical communication with the collimating lens and oriented relative to the principal efficiency axes of the optical monitor so that the ordinary and extraordinary axes of the wedge are offset from the principal efficiency axes of the optical monitor by a predetermined amount, a thickness of the wedge varying along a direction substantially perpendicular to a direction of propagation of the collimated optical beam;
a diffraction device in optical communication with the wedge for spatially diffracting the optical beam emitted from the wedge; and
a detector array in optical communication with the diffraction device so that the diffracted optical beam is imaged on the detector array.

2. The optical monitor device of claim 1, wherein the predetermined amount is approximately 45 degrees.

3. The optical monitor device of claim 1, wherein the thickness of the wedge of birefringent material substantially linearly varies along the direction substantially perpendicular to the direction of propagation of the collimated optical beam.

4. The optical monitor device of claim 1, further comprising a glass wedge disposed adjacent the wedge of birefringent material.

5. The optical monitor device of claim 4, wherein a thickness of the glass wedge varies along the direction substantially perpendicular to the direction of propagation of the collimated optical beam.

6. The optical monitor device of claim 4, wherein the wedge of birefringent material is spaced from the glass wedge.

7. The optical monitor device of claim 4, wherein the wedge of birefringent material and the glass wedge are attached to each other.

8. The optical monitor device of claim 4, wherein the thickness of the wedge of birefringent material and the thickness of the glass wedge vary in substantially equal and opposite directions along the direction substantially perpendicular to the direction of propagation of the collimated optical beam.

9. The optical monitor device of claim 4, wherein a thickness of the glass wedge varies substantially linearly along the direction substantially perpendicular to the direction of propagation of the collimated optical beam.

10. The optical monitor device of claim 4, wherein the glass wedge comprises non-birefringent glass.

11. The optical monitor device of claim 4, wherein the glass wedge comprises birefringent glass.

12. The optical monitor device of claim 4, wherein the glass wedge reduces an amount of angular refraction of the collimated beam caused by the wedge of birefringent material.

13. The optical monitor device of claim 1, wherein the diffraction device comprises a diffraction grating.

14. The optical monitor device of claim 1, wherein the diffraction device is a reflective diffraction grating.

15. The optical monitor device of claim 1, wherein the diffraction device is a transmissive diffraction device.

16. The optical monitor device of claim 15, further comprising a second lens assembly disposed between the transmissive diffraction device and the detector array.

17. The optical monitor device of claim 1, further comprising:
a second lens assembly disposed between the wedge of birefringent material and the diffraction device, for focusing an optical beam passing through the wedge of birefringent material onto a first intermediate spot; and
a third lens assembly disposed between the second lens assembly and the diffraction device and between the diffraction device and the detector array, for substantially collimating an optical beam focused at the first intermediate spot.

18. The optical monitor device of claim 17, further comprising:
a fourth lens assembly disposed in optical communication between the diffraction device and the detector array, for focusing light diffracted by the diffraction device towards the detector array.

19. The optical monitor device of claim 1, wherein the optical beam emitted from the end of the fiber optic line passes through the wedge of birefringent material one time.

20. The optical monitor device of claim 1, wherein the optical beam emitted from the end of the fiber optic line passes through the wedge of birefringent material at least two times.

21. A method for monitoring one or more optical signals in an optical communications network, comprising the steps of:
receiving a beam of one or more optical signals;
collimating the beam to produce a substantially collimated optical beam having a substantially uniform polarization state;
modifying the collimated optical beam so that the polarization state of the modified beam spatially varies as a function of a sinusoid and that the polarization state of the modified beam is approximately equal to two orthogonal linear polarization states with no relative phase relationship when spatially averaged; and
diffracting the modified beam as a function of wavelength so that the diffracted modified beam is incident on at least one detector element.

22. The method of claim 21, wherein the step of modifying results in the method having an approximately zero polarization dependent loss.

23. The method of claim 21, wherein at least one period of the spatially varying polarization state of the modified beam occurs.

24. The method of claim 21, wherein the step of modifying comprises passing the collimated optical beam through a wedge of birefringent material.

25. An apparatus for monitoring optical signals, comprising:
an input for receiving an end portion of at least one fiber optic line;
a lens assembly for collimating an optical beam appearing at the end portion of the at least one fiber optic line;
means, in optical communication with the lens assembly, for modifying the optical beam so that a polarization state of the optical beam varies as a sinusoidal function along at least one direction;
a diffraction device in optical communication with the means for modifying and having a pair of principal efficiency axes, the polarization state of the optical beam is approximately 45 degrees offset from a principal efficiency axis of the diffraction device; and
an optical detector in optical communication with the diffraction device, for detecting light diffracted by the diffraction device.

26. The apparatus of claim 25, wherein the means for modifying comprises a wedge of birefringent material having a thickness that substantially linearly varies along a direction substantially perpendicular to a direction of propagation of the optical beam.

27. The apparatus of claim 26, wherein the wedge of birefringent material has an ordinary axis and an extraordinary axis that are offset from the pair of principal efficiency axes of the diffraction device by approximately 45 degrees.

28. The apparatus of claim 26, further comprising a wedge of glass material disposed in optical communication with the wedge of birefringent material and the diffraction device, the wedge of glass material serving to reduce the angle of refraction of the optical beam caused by the wedge of birefringent material.

29. The apparatus of claim 28, wherein the wedge of glass material has a thickness that varies substantially linearly along a direction substantially perpendicular to a direction of propagation of the optical beam.

30. The apparatus of claim 29, wherein the wedge of glass material and the wedge of birefringent material are connected together to form a single optical component.
